(19) United States
(12) Patent Application Publication
(10) Pub. No.: US 2007/0006256 A1
(43) Pub. Date: Jan. 4, 2007

(54) Digital video processing apparatus and control method thereof

(75) Inventor: Ji-won Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/357,099

(22) Filed: Feb. 21, 2006

(30) Foreign Application Priority Data
Jul. 4, 2005 (KR) 10-2005-0059922

(51) Int. Cl. H04N 5/445

(52) U.S. Cl. 725/38; 725/39; 725/44; 348/731

(57) ABSTRACT

A digital video processing apparatus supporting a directed channel change (DCC) function, includes an image processor that outputs information about a plurality of change candidate channels when the DCC function identifies the plurality of change candidate channels. Thus, the digital video processing apparatus provides an interface image that allows a user to select a particular ones of a plurality of change candidate channels received through a DCC function without difficulty.

### CROSS-REFERENCE TO RELATED APPLICATIONS

This application is based upon and claims priority from Korean Patent Application No. 10-2005-0059922, filed on Jul. 4, 2005, in the Korean Intellectual Property Office, the disclosure of which is incorporated herein in its entirety by reference.

### BACKGROUND OF THE INVENTION

1. Field of the Invention

Devices, systems, and methods consistent with the invention relate to digital video processing, and more particularly, to digital video processing which allows a user to select a channel from a plurality of change candidate channels received through a directed channel change (DCC) function.

2. Description of the Related Art

Generally, a related art digital video processing apparatus receives a digital video signal, a digital audio signal and a digital data signal, which are compressed. The digital data signal includes: (1) program information; and (2) data in accordance with a Program and System Information Protocol (PSIP).

The PSIP is a standard set by the Advanced Television System Committee (ATSC) for terrestrial and cable digital TVs. The PSIP comprises a master guide table (MGT), a virtual channel table (VCT), an event information table (EIT), an extended time table (ETT), a rating region table (RRT) and a system time table (STT). The PSIP further comprises a directed channel change table (DCCT) and a directed channel change selection code table (DCCSCT) as extended standards to support the DCC function.

When the DCC function is enabled, a first channel which is displayed for a user on a display part will be automatically changed to a second channel by the DCC function (according to instructions in the DCCT) when the content of the second channel satisfies the user's preset conditions (i.e., without the user's interaction). Additionally, upon reaching a predetermined returning time point, the second channel is changed back to the first channel.

However, in the related art digital video processing apparatus described above, it is possible that the contents of a plurality of second channels will satisfy the user's preset conditions (i.e., there will be a plurality of change candidate channels). In this case, a single one of the plurality of change candidate channels may be arbitrarily selected, without the user's input, to display on the display part. Thus, the user may not know that other change candidate channels exist, and therefore cannot select between the plurality of change candidate channels.

### SUMMARY OF THE INVENTION

Accordingly, it is an aspect of the invention to provide a digital video processing apparatus, and control method therefor, which allows a user to select a channel from a plurality of change candidate channels received through a directed channel change (DCC) function.

According to an aspect of the invention, there is provided a digital video processing apparatus supporting a directed channel change (DCC) function, including an image processor that outputs information about a plurality of change candidate channels when the DCC function identifies the plurality of change candidate channels.

According to an aspect of the invention, the digital video processing apparatus further includes a signal receiver that receives the DCC function.

According to an aspect of the invention, the digital video processing apparatus further includes a display part that displays the information about the plurality of change candidate channels.

According to an aspect of the invention, the DCC function uses a directed channel change table (DCCT).

According to an aspect of the invention, the DCC function identifies the plurality of change candidate channels by comparing information in a directed channel change table (DCCT) with user information stored in the digital video processing apparatus.

According to an aspect of the invention, the image processor outputs, as a display picture, images received through an original channel viewed before operation of the DCC function, and outputs the information about the plurality of change candidate channels as a part of the display picture.

According to an aspect of the invention, the image processor outputs images received through a selected one of the plurality of change candidate channels as another part of the display picture.

According to an aspect of the invention, the image processor outputs, as a display picture, images received through a first one of the plurality of change candidate channels, and outputs information about remaining ones of the plurality of change candidate channels as a part of the display picture.

According to an aspect of the invention, the image processor outputs images received through a selected one of the remaining ones of the plurality of change candidate channels as another part of the display picture.

According to an aspect of the invention, the DCCT function comprises a change time point indicating when an original channel will be changed to one of the plurality of change candidate channels, and when the change time point occurs, the image processor outputs images received through a first one of the plurality of change candidate channels as a full picture on a display part, and outputs information about remaining ones of the plurality of change candidate channels on a part of the display part.

According to an aspect of the invention, the image processor outputs images received through a selected one of the remaining ones of the plurality of change candidate channels on another part of the display part.

According to an aspect of the invention, the image processor further outputs images received through a selected one of the plurality of change candidate channels.

According to an aspect of the invention, the information about the plurality of change candidate channels comprises at least one of a channel number, a program title and a genre of the respective change candidate channels.

According to an aspect of the invention, the image processor further outputs images received through a set one of the plurality of change candidate channels as a sole display picture for final viewing.

According to an aspect of the invention, there is provided a method of controlling a digital video processing apparatus supporting a directed channel change (DCC) function, the method including outputting information about a plurality of change candidate channels when the DCC function identifies the plurality of change candidate channels.

According to an aspect of the invention, the method further includes receiving the DCC function via a signal receiver.

According to an aspect of the invention, the method further includes displaying the information about the change candidate channels.

According to an aspect of the invention, the DCC function uses a directed channel change table (DCCT).

According to an aspect of the invention, the DCC function identifies the plurality of change candidate channels by comparing information in a directed channel change table (DCCT) with user information stored in the digital video processing apparatus.

According to an aspect of the invention, the method further includes outputting, as a display picture, images received through an original channel viewed before operation of the DCC function; and outputting the information about the plurality of change candidate channels as a part of the display picture.

According to an aspect of the invention, the method further includes outputting images received through a selected one of the plurality of change candidate channels as another part of the display picture.

According to an aspect of the invention, the method further includes outputting, as a display picture, images received through a first one of the plurality of change candidate channels; and outputting information about remaining ones of the plurality of change candidate channels as a part of the display picture.

According to an aspect of the invention, the method further includes outputting images received through a selected one of the remaining ones of the plurality of change candidate channels as another part of the display picture.

According to an aspect of the invention, the DCCT function includes a change time point indicating when an original channel will be changed to one of the plurality of change candidate channels; and when the change time point occurs, the method further comprises outputting images received through a first one of the plurality of change candidate channels as a full picture on the display part, and outputting information about remaining ones of the plurality of change candidate channels on a part of the display part.

According to an aspect of the invention, the method further includes displaying images received through a selected one of the remaining ones of the plurality of change candidate channels on another part of the display part.

According to an aspect of the invention, the method further includes selecting one of the plurality of change candidate channels; and displaying an images received through the selected one of the plurality of change candidate channels.

According to an aspect of the invention, the information about the plurality of change candidate channels comprises at least one of a channel number, a program title and a genre of the respective change candidate channels.

According to an aspect of the invention, the method further includes setting one of the plurality of change candidate channels; and outputting images received through the set one of the plurality of change candidate channels as a sole display picture for final viewing.

### BRIEF DESCRIPTION OF THE DRAWINGS

The above and/or other aspects of the invention will become more apparent by describing in detail exemplary embodiments of the invention with reference to the accompanying drawings, in which:

FIG. 1 is a control block diagram of a digital video processing apparatus according to an exemplary embodiment of the invention;

FIG. 2 is an image displayed on a display part according to an exemplary embodiment of the invention; and

FIG. 3 is a control flowchart of the digital video processing apparatus according to an exemplary embodiment of the invention.

### DETAILED DESCRIPTION OF EXEMPLARY EMBODIMENT

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

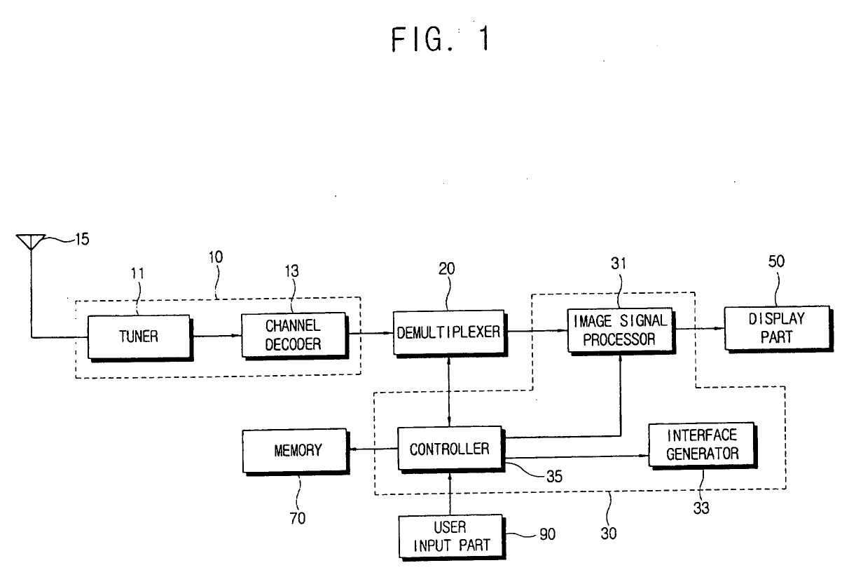

As shown in FIG. 1, a digital video processing apparatus according to an exemplary embodiment of the invention comprises an antenna 15; a signal receiver 10 to receive a digital broadcast signal through the antenna 15; a demultiplexer 20 to divide the broadcast signal received from the signal receiver 10; and an image processor 30 to process the divided broadcast signal. The digital video processing apparatus may further comprise a display part 50; a memory 70 to store predetermined user information therein; and an user input part 90.

The signal receiver 10 receives the digital broadcast signal from the antenna 15. The signal receiver 10 comprises a tuner 11 and a channel decoder 13. The digital broadcast signal is transmitted as a transport stream in which the digital video signal, the digital audio signal and the digital data information are multiplexed in a time division manner and packeted.

The tuner 11 tunes the broadcast signal received through the antenna 15 into a broadcast signal having a frequency band corresponding to a tuning control signal of the image processor 30 (to be described later).

That is, the tuner 11 selects the broadcast signal corresponding to the channel to be displayed on the display part 50 among a plurality of broadcast signals received through the antenna 15, and outputs it to the channel decoder 13. Then, the channel decoder 13 restores the digital broadcast signal detected from the broadcast signals received from the tuner 11 by packet, and outputs it to the demultiplexer 20.

The demultiplexer 20 divides the digital audio signal, the digital video signal, and the digital data information of the digital broadcast signal in the restored packet, into individual bit rows and outputs them to the image processor 30.

The data information comprises program and system information protocol (PSIP) data. The PSIP data comprises, inter alia, a directed channel change table (DCCT) for the DCC function, where the DCCT has the structure of Table 1.

TABLE 1

| Syntex | Bits | Format |
|---|---|---|
| directed_channel_change_table_section( ){ | | |
| table_id | 5 | OxD3 |

. . .

| | | |
|---|---|---|
| dcc_from_major_channel_number | 10 | uimsbf |
| dcc_from_minor_channel_number | 10 | uimsbf |
| reserved | 4 | ‘1111’ |
| dcc_to_major_channel_number | 10 | uimsbf |
| dcc_to_minor_channel_number | 10 | uimsbf |
| dcc_start_time | 32 | uimsbf |
| dcc_end_time | 32 | uimsbf |
| dcc_term_count | 8 | uimsbf |
| For(j=0<dcc_term_count; j++){ | | |
| dcc_selection_type | 8 | uimsbf |
| dcc_selection_id | 64 | uimsbf |

. . .

| | | |
|---|---|---|
| CRC_32 | 32 | rpchof |
| } | | |

If the digital video processing apparatus according to the exemplary embodiment receives the DCCT while the DCC function is enabled by a user's selection, etc., the channel is changed as follows.

While a viewer views a first channel (dcc_from_major_channel_number, dcc_from_minor_channel_number) on the display part 50, if selection information with respect to a second channel (dcc_selection_id of dcc_selection_type) in the DCCT conforms to user information (e.g., gender, region, age, favorite genres) set by a user in the digital video processing apparatus, the first channel is changed to the second channel (dcc_to_major_channel_number, dcc_to_minor_channel_number) at a change time point (dcc_start_time). The second channel is changed back to the first channel (i.e., the original channel) at a returning time point (dcc_end_time).

If a user manually changes back to the first channel, or to a third channel, before the returning time point, or if a newDCCT table containing instructions to stop the DCC function (i.e., where dcc_selection_type=OxOF) is supplied, the DCC function is disabled.

Further, if selection information in the DCCT with respect to a plurality of channels conforms to the user information (rather than just the second channel), the display part displays information about all of these channels for the user's review. In other words, the display part displays information about a plurality of change candidate channels so that the user may select therebetween.

With respect to FIG. 1, the image processor 30 outputs the information about the plurality of change candidate channels identified in the DCCT when the plurality of change candidate channels conform to the user information. For example, if the channels 20 and 21 both conform to the user information, the image processor 30 outputs information regarding both of these channels to the display part 50.

The image processor 30 includes an image signal processor 31, an interface generator 33 and a controller 35. The image signal processor 31 converts the image signal output from the demultiplexer 20 into a signal displayable by the display part 50 to output it to the display part 50. The interface generator 33 generates a predetermined interface image to be displayed on the display part 50.

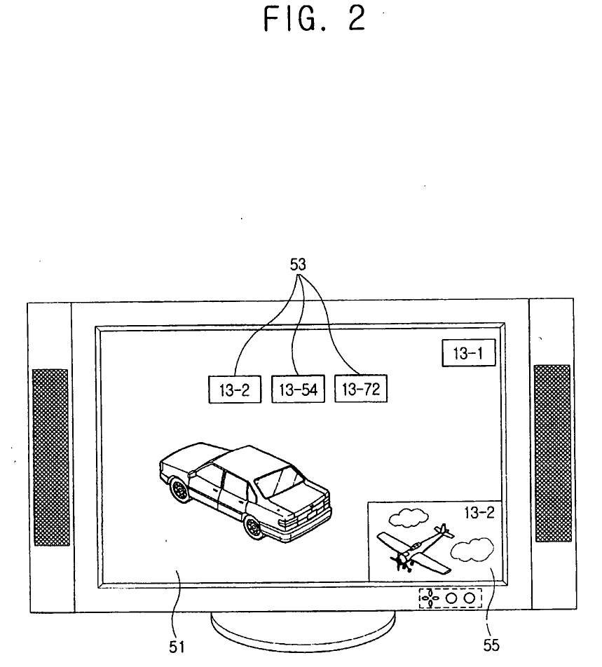

As a matter of further explanation, as shown in FIG. 2, when the change time point indicated in the DTTC is reached (dcc_start_time), the digital video processing apparatus changes the first channel displayed on the display part 50 to one of the plurality of change candidate channels. In other words, the controller 35 controls at least one of the interface generator 33 and the image signal processor 31 to display an image received through a first one of the plurality of change candidate channels (refer to 51 in FIG. 2) on the display part 50. Additionally, information about remaining ones of the plurality of change candidate channels (i.e., the ones of the change candidate channels other than the first one having its image displayed) is also displayed on the display part 50 (refer to 53 in FIG. 2).

Alternatively, the digital video processing apparatus may simply display the information about the plurality of change candidate channels without changing the first channel to one of the plurality of change candidate channels.

Then, if the user selects one of the remaining ones of the plurality of change candidate channels for viewing, the image processor 30 may control the image displayed on the display part 50 to be changed to an image received through the selected one of the remaining ones of the plurality of change candidate channels.

Alternatively, the image processor 30 may output the image received through the selected one of the remaining ones of the plurality of change candidate channels, on a part of the display part 50 as an additional image 55 (e.g., a Picture in Picture (PIP) image). In this manner, the user may cycle through the remaining ones of the plurality of change candidate channels if desired.

Here, the information about the change candidate channels may comprise program titles, genres, or channel nos. of the corresponding channels.

Lastly, the user may set one of the plurality of change candidate channels for final viewing, whereupon the image processor 30 will output only the images received through the set change candidate channel.

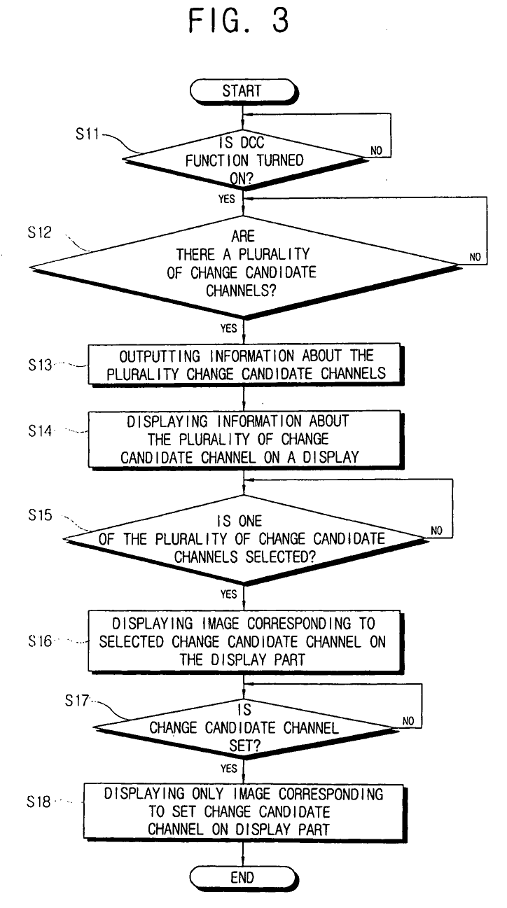

A further description of an exemplary method according to the invention is shown in FIG. 3. Specifically, at operation S11, it is determined whether a digital video processing apparatus has the DCC function turned on.

In operation S12, it is determined whether a plurality of channels received in the broadcast signal and identified in the DCCT conform to user information stored in memory 70 (i.e., if there are a plurality of change candidate channels).

At operation S13 the image processor 30 outputs information about the plurality of change candidate channels at the change time point (dcc_start_time) included in the DCCT or a predetermined time before the change time point (dcc_start_time).

In operation S14, the display part 50 displays the information about the plurality of change candidate channels thereon through an output of the image processor 30. The image corresponding to a first one of the plurality of change candidate channels may be displayed on the display part 50 as a whole, while information about the remaining ones of the plurality of change candidate channels may be displayed on a part of the display part 50 as shown in FIG. 2. Alternatively, information about all of the respective change candidate channels may be displayed on a part of the display part 50 wihout displaying images corresponding to the first one of the plurality of change candidate channels.

In operation S15, it is determined whether one of the change candidate channels is selected for review by the user. For example, it is determined if one of the remaining ones of the plurality of change candidate channels 53 in FIG. 2 is selected.

In operation S16, the image processor 30 outputs the image signal corresponding to the selected change candidate channel to be displayed as the main image 51 on the display part 50. Alternatively, the image processor 30 may output the image signal corresponding to the selected change candidate channel as a PIP image 53 on the display part 50.

In operation S17, it is determined whether one of the plurality of change candidate channels is set by the user for final viewing.

In operation S18, when one of the plurality of change candidate channels is set, the image processor 30 changes its output to only an image received through the set change candidate channel on the display part 50.

The display part 50 may be provided in the digital video processing apparatus according to the exemplary embodiment, but is not limited thereto. Alternatively, the display part 50 may be provided as a separate device.

For example, if the digital video processing apparatus according to the invention is provided as a set top box, the digital video processing apparatus may be separable from the display apparatus. Accordingly, the digital video processing apparatus would not include the display part 50. However, if the digital video processing apparatus according to the invention is integrally provided in the display apparatus, the digital video processing apparatus would include the display part 50.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A digital video processing apparatus supporting a directed channel change (DCC) function, the digital video processing apparatus comprising an image processor that outputs information about a plurality of change candidate channels when the DCC function identifies the plurality of change candidate channels.

2. The digital video processing apparatus according to claim 1, further comprising a signal receiver that receives the DCC function.

3. The digital video processing apparatus according to claim 1, further comprising a display part that displays the information about the plurality of change candidate channels.

4. The digital video processing apparatus according to claim 1, wherein the DCC function uses a directed channel change table (DCCT).

5. The digital video processing apparatus according to claim 1, wherein the DCC function identifies the plurality of change candidate channels by comparing information in a directed channel change table (DCCT) with user information stored in the digital video processing apparatus.

6. The digital video processing apparatus according to claim 1, wherein the image processor outputs, as a display picture, images received through an original channel viewed before operation of the DCC function, and outputs the information about the plurality of change candidate channels as a part of the display picture.

7. The digital video processing apparatus according to claim 6, wherein the image processor outputs images received through a selected one of the plurality of change candidate channels as another part of the display picture.

8. The digital video processing apparatus according to claim 1, wherein the image processor outputs, as a display picture, images received through a first one of the plurality of change candidate channels, and outputs information about remaining ones of the plurality of change candidate channels as a part of the display picture.

9. The digital video processing apparatus according to claim 8, wherein the image processor outputs images received through a selected one of the remaining ones of the plurality of change candidate channels as another part of the display picture.

10. The digital video processing apparatus according to claim 1, wherein:
the DCCT function comprises a change time point indicating when an original channel will be changed to one of the plurality of change candidate channels, and
when the change time point occurs, the image processor outputs images received through a first one of the plurality of change candidate channels as a full picture on a display part, and outputs information about remaining ones of the plurality of change candidate channels on a part of the display part.

11. The digital video processing apparatus according to claim 10, wherein the image processor outputs images received through a selected one of the remaining ones of the plurality of change candidate channels on another part of the display part.

12. The digital video processing apparatus according to claim 1, wherein the image processor further outputs images received through a selected one of the plurality of change candidate channels.

13. The digital video processing apparatus according to claim 1, wherein the information about the plurality of change candidate channels comprises at least one of a channel number, a program title and a genre of the respective change candidate channels.

14. The digital video processing apparatus according to claim 1, wherein the image processor further outputs images received through a set one of the plurality of change candidate channels as a sole display picture for final viewing.

15. A method of controlling a digital video processing apparatus supporting a directed channel change (DCC) function, the method comprising outputting information about a plurality of change candidate channels when the DCC function identifies the plurality of change candidate channels.

16. The method according to claim 15, further comprising receiving the DCC function via a signal receiver.

17. The method according to claim 15, further comprising displaying the information about the plurality of change candidate channels.

18. The method according to claim 15, wherein the DCC function uses a directed channel change table (DCCT).

19. The method according to claim 15, wherein the DCC function identifies the plurality of change candidate channels by comparing information in a directed channel change table (DCCT) with user information stored in the digital video processing apparatus.

20. The method according to claim 15, further comprising:
outputting, as a display picture, images received through an original channel viewed before operation of the DCC function; and
outputting the information about the plurality of change candidate channels as a part of the display picture.

21. The method according to claim 20, further comprising outputting images received through a selected one of the plurality of change candidate channels as another part of the display picture.

22. The method according to claim 15, further comprising:
outputting, as a display picture, images received through a first one of the plurality of change candidate channels; and
outputting information about remaining ones of the plurality of change candidate channels as a part of the display picture.

23. The method according to claim 22, further comprising outputting images received through a selected one of the remaining ones of the plurality of change candidate channels as another part of the display picture.

24. The method according to claim 15, wherein:
the DCCT function comprises a change time point indicating when an original channel will be changed to one of the plurality of change candidate channels; and
when the change time point occurs, the method further comprises outputting images received through a first one of the plurality of change candidate channels as a full picture on the display part, and outputting information about remaining ones of the plurality of change candidate channels on a part of the display part.

25. The method according to claim 24, further comprising displaying images received through a selected one of the remaining ones of the plurality of change candidate channels on another part of the display part.

26. The method according to claim 15, further comprising:
selecting one of the plurality of change candidate channels; and
displaying an images received through the selected one of the plurality of change candidate channels.

27. The method according to claim 15, wherein the information about the plurality of change candidate channels comprises at least one of a channel number, a program title and a genre of the respective change candidate channels.

28. The method according to claim 15, further comprising:
setting one of the plurality of change candidate channels; and
outputting images received through the set one of the plurality of change candidate channels as a sole display picture for final viewing.
